(19) United States
(12) Patent Application Publication
(10) Pub. No.: US 2005/0011858 A1
(43) Pub. Date: Jan. 20, 2005

(54) Method for fabricating a hollow micro-needle array

(75) Inventors: Shyh-Chyi Kuo, Yangmei Jen (TW); Hsiang-Fu Chen, Judung Jen (TW)

Correspondence Address: TUNG & ASSOCIATES, Suite 120, 838 W. Long Lake Road, Bloomfield Hills, MI, 48302, US

(73) Assignee: INDUSTRIAL TECHNOLOGY RESEARCH INSTITUTE

(21) Appl. No.: 10/622,892

(22) Filed: Jul. 16, 2003

(51) Int. Cl. B44C 1/22

(52) U.S. Cl. 216/17

(57) ABSTRACT

A method for fabricating a hollow micro-needle array by first providing a silicon substrate; depositing a protective layer on the silicon substrate; defining a plurality of regions for wet etching; wet etching the silicon substrate forming a plurality of recesses that have inclined sidewalls; and continuing processing by electroplating, imaging/developing or micro-machining the plurality of recesses forming a hollow micro-needle array.

### FIELD OF THE INVENTION

The present invention generally relates to a method for fabricating a hollow micro-needle array and the array fabricated. More particularly, the present invention relates to a method for fabricating a hollow micro-needle array wherein each of the micro-needles has a sharp end to facilitate penetration and the array fabricated.

### BACKGROUND OF THE INVENTION

Hollow micro-needle arrays have been used in medical technology for taking blood samples, for taking other fluid samples in minute quantities and for injection of medicine in biotechnology applications. Hollow micro-needle arrays which are fabricated of various types of materials, i.e., semiconductor materials, polymeric materials or metals have been utilized. When semiconductor materials are used for fabricating hollow micro-needle arrays, the arrays are mostly formed on silicon-based wafers or substrates. A conventional process utilizing semiconductor materials for fabricating hollow micro-needle arrays requires numerous steps of dry etching, wet etching and thin film deposition. The fabrication process is complicated and time consuming. As a consequence, the yield of the process is poor and the fabrication cost is high.

Hollow micro-needles fabricated by the conventional process usually have ends formed in spherical shape and thus are difficult for penetration during use. Moreover, the internal passageway in the micro-needle is normally larger at the root end of the needle compared to the tip end of the needle which limits the flow of fluid that passes through the micro-needle. In order to maintain the size of the internal passageway constant and the structural strength of the micro-needle, it is difficult to increase the array density for the micro-needles. As a result, the amount of the fluid sample taken by the micro-needles or the amount of fluid delivered by the micro-needles is frequently insufficient. The smaller internal passageway further increases the resistance to the fluid flow, thus requiring a larger driving force at the root end of the micro-needle which in turn increases the cost of the equipment that utilizes the micro-needle array.

For conventional micro-needles that are equipped with spherical ends, i.e., without sharp points, the force required on the micro-needle for penetrating an organism is sufficiently high such that the needle must be constructed with sufficient strength by increasing its size in order to avoid the possibility of needle breakage during use.

It is therefore an object of the present invention to provide a method for fabricating a hollow micro-needle array that does not have the drawbacks or shortcomings or the conventional methods.

It is another object of the present invention to provide a hollow micro-needle array that can be fabricated by using semiconductor materials and processes.

It is a further object of the present invention to provide a hollow micro-needle array that can be fabricated with reduced fabrication steps and at low cost.

### SUMMARY OF THE INVENTION

In accordance with the present invention, a method for fabricating a hollow micro-needle array and the hollow micro-needle array fabricated are disclosed.

In a preferred embodiment, a method for fabricating a hollow micro-needle array can be carried out by the operating steps of providing a silicon substrate; depositing a protective layer on the silicon substrate; defining a plurality of regions for wet etching; wet etching the silicon substrate forming a plurality of recesses each having inclined sidewalls; and continuing processing the plurality of recesses forming a hollow micro-needle array.

In the method for fabricating a hollow micro-needle array, the continuing processing step is selected from the group consisting of electroplating, imaging/developing and micro-machining. The method may further include the step of providing a polymeric substrate instead of the silicon substrate, and forming the plurality of recesses with inclined sidewalls by a laser processing technique. The method may further include the step of providing a photoresist material instead of the silicon substrate, and forming the plurality of recesses having inclined sidewalls by imaging and developing. A tip portion of a micro-needle in the hollow micro-needle array is at least partially formed with an inclined plane. The continuing processing step may further include the sub-steps of photolithographically developing a photoresist material on top of the silicon substrate and forming a plurality of recesses; plating a metal in the plurality of recesses forming a plurality of metal micro-needles; removing the photoresist material exposing the plurality of hollow metal micro-needles; and etching the silicon substrate forming a plurality of hollow metal micro-needles. The method may further include the step of depositing a starting metal layer on the silicon substrate in the plurality of recesses that have inclined sidewalls.

In the method, the plating step is selected from the group consisting of electroplating, electroless plating, evaporation and sputtering. The metal may be selected from the group consisting of copper, chromium, nickel, iron, gold, platinum, palladium, their alloys and stainless steel. The removal step for the photoresist material and the hollowing process for the micro-needles are carried out by a technique selected from the group consisting of laser processing, etching and photolithography. The method may further include the step of using the silicon substrate with the metal micro-needles as a mold for fabricating a multiplicity of micro-needles. The multiplicity of micro-needles can further be fabricated by micro-injection molding or a micro-thermal compression forming technique.

The present invention is further directed to a method for fabricating a hollow micro-needle array which can be carried out by the operating steps of providing a silicon substrate; depositing a protective layer on the silicon substrate; defining a plurality of wet etch regions; wet etching the plurality of wet etch regions on the silicon substrate forming a plurality of recesses, each having inclined sidewalls; depositing sequentially an anti-reflective coating layer and a sacrificial layer on top of the silicon substrate; depositing a photoresist layer; imaging the photoresist layer forming the micro-needle array; removing the sacrificial layer obtaining a bottom layer with inclined sidewalls; and developing the bottom layer forming a micro-needle array.

The method for fabricating a hollow micro-needle array may further include the step, after the deposition of the photoresist layer, of removing the sacrificial layer and then imaging and developing the bottom structure. The sacrificial layer may be a mold release layer. The method may further include the repeated steps of depositing the photoresist layer and imaging the photoresist layer such that an internal diameter of the flow passageway in the micro-needle array is changed for serving as a storage function.

The present invention is still further directed to a method for fabricating a hollow micro-needle array which can be carried out by the operating steps of providing a silicon substrate; depositing a protective layer on top of the silicon substrate; defining a plurality of wet etching regions; wet etching the silicon substrate forming a plurality of recesses each having inclined sidewalls; depositing a sacrificial layer on top of the silicon substrate; compression molding by using a material having sufficient plasticity; removing the sacrificial layer; forming a bottom structure having inclined sidewalls and micro-machining the silicon substrate forming a micro-needle array.

In the method for fabricating a hollow micro-needle array, the sacrificial layer may be a mold release layer. The material that has sufficient plasticity is selected from thermoplastic materials and thermosetting materials. The compression molding step for the material with sufficient plasticity can be replaced by an injection molding process. The micro-processing step may include laser processing steps or etching steps.

### BRIEF DESCRIPTION OF THE DRAWINGS

These and other objects, features and advantages of the present invention will become apparent from the following detailed description and the appended drawings in which:

FIGS. 1A-1H are enlarged, cross-sectional views illustrating the fabrication process steps for the present invention first-preferred embodiment.

FIGS. 2A-2F are enlarged, cross-sectional views illustrating the fabrication process steps for the present invention second preferred embodiment.

FIGS. 3A-3C are enlarged, cross-sectional views illustrating the fabrication process steps for the present invention third preferred embodiment.

FIGS. 4A-4H are enlarged, cross-sectional views illustrating the fabrication process steps for the present invention fourth preferred embodiment.

FIGS. 5A-5G are enlarged, cross-sectional views illustrating the fabrication process steps for the present invention fifth preferred embodiment.

FIG. 6 are enlarged perspective and cross-sectional views illustrating the various recesses with inclined sidewalls and the shapes of the sharp points obtained for the micro-needles.

FIG. 7 are enlarged perspective and cross-sectional views illustrating the present invention recesses with inclined sidewalls and the sharp pointed micro-needles obtained.

FIGS. 8A-8H are enlarged, cross-sectional views illustrating the fabrication process steps for the present invention sixth preferred embodiment.

### DETAILED DESCRIPTION OF THE PREFERRED AND ALTERNATE EMBODIMENTS

The present invention discloses a method for fabricating a hollow micro-needle array with a simplified procedure at lower fabrication costs. In the method, micro-needles are fabricated each having an end with inclined surfaces, i.e. a sharp end. Since the sharp end of the micro-needles easily penetrates into an organism, the present invention hollow micro-needle array can be advantageously used in applications for drug dispensing and sampling.

The present invention fabrication process for hollow micro-needle array can be started by a wet etch process carried out on a silicon wafer or a silicon substrate forming an indentation that has inclined sidewalls. The indentation is then used as a mold such a that micro-needle array can be produced by various technologies such as metal plating, imaging/developing and micro-processing.

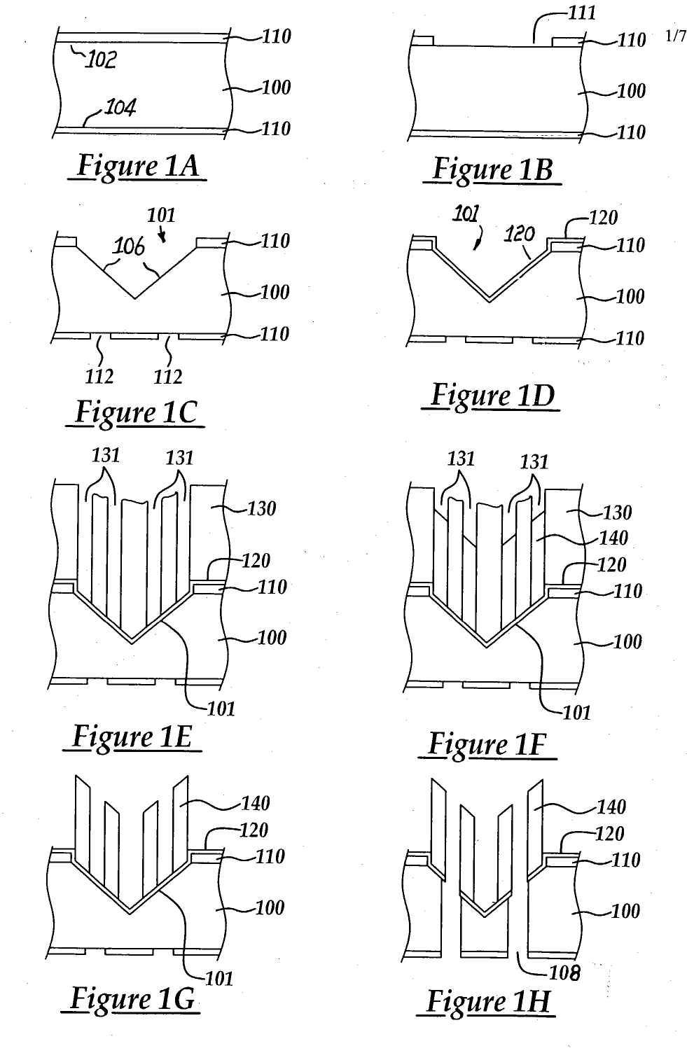

Referring initially to FIGS. 1A-1H, wherein enlarged, cross-sectional views illustrating fabrication process steps for the present invention first preferred embodiment for fabricating a hollow micro-needle array are shown. The process starts with a silicon wafer 100 with its top surface 102, bottom surface 104 covered by a protective layer 110. The protective layer 110 can be advantageously formed of silicon nitride. This is shown in FIG. 1A. In the next step of the process, shown in FIG. 1B, a photoresist layer (not shown) is used to image and define an area 111 for a future wet etching process by etching away the protective layer 110. The wet etch area 111 is then wet etched to expose the silicon wafer 100, as shown in FIG. 1C. Due to the an-isotropic nature of the wet etch process, a recess 101 that is formed with inclined sidewalls 106 is formed.

A photolithographic method is then carried out on the bottom protective layer 110 to define areas 112 which will to be dry etched. As shown in FIG. 1D, on top of the silicon wafer 100 is then performed a physical vapor deposition (or an evaporation method) to coat a metal layer 120 on top of the top protective layer 110. A suitable metal layer 120 can be deposited of a metal such as chromium, nickel or copper. A second photolithographic method is then carried out, as shown in FIG. 1E, on top of the first metal layer 120 by first depositing a photoresist layer 130 on top of the first metal layer 120. In the photoresist layer 130, is then formed a plurality of plating areas 131 exposing partially the first metal layer 120. The to be plated areas 131 are formed in a hollow micro-needle shape. This is shown in FIG. 1E.

In the next step of the process, the plating area 131 is filled with a plating metal on top of the first metal layer 120. A suitable plating metal may be copper or nickel. A metal micro-needle 140 is thus formed, as shown in FIG. 1F. Since the metal atoms are arranged on the inclined surface 106 of the recess 101 during the plating process, the metal micro-needle 140 is formed with a sharp end shown in FIG. 1F. In the final step of the process, as shown in FIG. 1G, a demolding step is carried out by removing the photoresist material 130 such that the hollow metal micro-needle 140 is exposed. The silicon wafer 100 is then dry etched to form apertures 108 through the metal micro-needle 140.

It should be noted that, in the above described process for forming the present invention first preferred embodiment micro-needle, the lithography process for defining the dry etch region 112 does not have to be carried out before the wet etch process, as long as it is carried out before the dry etch process. Furthermore, the plating technique for the metal can be advantageously selected from electroplating, electroless plating, evaporation or sputtering. The deposition of the starting metal layer 120 is therefore not absolutely necessary. The metal material can be selected from nickel, iron, gold, platinum, palladium, alloys of these metals or stainless steel. The formation of the recess on the silicon wafer 100 may also be carried out by a dry etch process, or carried out on other substrate materials such as PMMA or photoresist materials and techniques such as laser processing or photo imaging/developing. A compression molding method may further be used to form the recess with the inclined sidewalls. The present invention first preferred embodiment therefore is not limited to a semiconductor formation process. Various other inclined surfaces of the micro-needle may also be formed, such as those shown as a single inclined surface in FIG. 6A, double inclined surfaces shown in FIG. 7A, or other shapes of the inclined surfaces shown in FIGS. 6B and 6C.

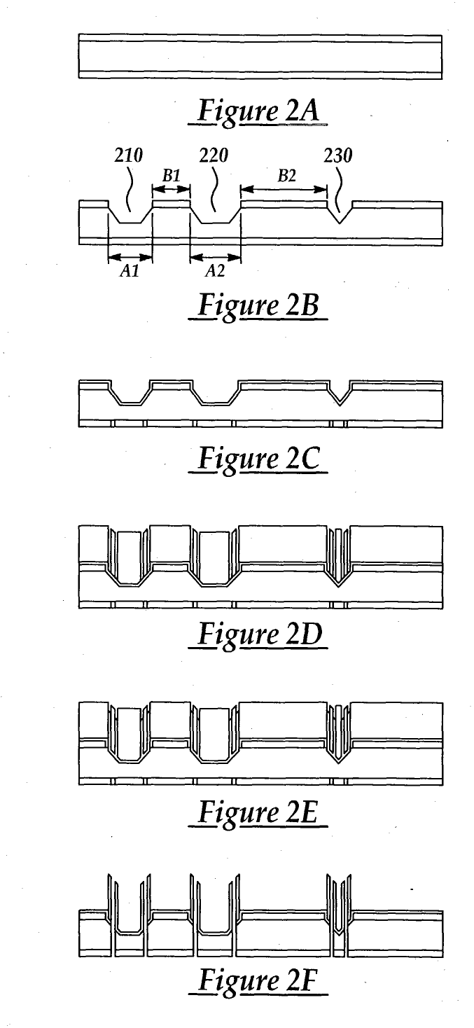

The density of the micro-needle array formed may be controlled during the lithographic process for defining the wet etched area. By controlling the length and the width of the wet etch area, and by the distance between the wet etch area and by the distance between the wet etch area. FIGS. 2A-2F illustrates fabrication process steps for a present invention second preferred embodiment. FIG. 2A is similar to that shown in FIG. 1A wherein protective layers 202 covers a silicon substrate 200. In the second step of the process, shown in FIG. 2B, the wet etch areas 210,220 are defined by a lithographic method with various internal distances A1 and A2. The density of the micro-needle array may further be controlled by defining different distances B1, B2 in between the wet etch areas 210,220 and 230 as shown in FIG. 2B. The resulting micro-needle array is shown in FIG. 2F. The other processing steps, shown in FIGS. 2C, 2D and 2E are similar to that described in FIGS. 1C, 1D and BE.

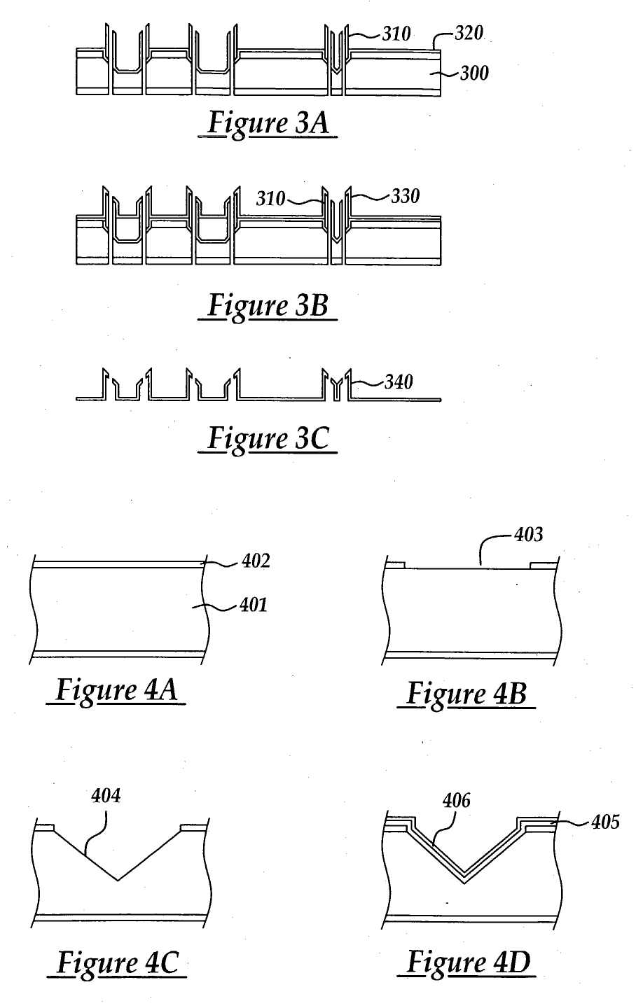

The above described processes may further be used for making other micro-needles with other materials by using the metal micro-needles as a mold. This is shown in FIGS. 3A-3C in a third preferred embodiment of the present invention fabrication method. In this embodiment, a mold release layer 320 such as teflon is first deposited on top of the silicon wafer 300 and in the metal micro-needle 310. The silicon wafer 300 and the metal micro-needle 310 are then heated, followed by pressing a thermoplastic film 330 of polymeric nature uniformly under pneumatic pressure on the metal micro-needle 310. After the thermoplastic thin film 320 conforms to the shape of the metal micro-needle 310, micro-needle 340 can be demolded after cooled. Other micro-needle arrays formed by various materials can thus be made by using the metal micro-needle as a mold by techniques such as micro injection molding, micro thermal compression molding or transfer molding. The demolding technique can be facilitated by heating, cooling, surface coating, or solvent demolding.

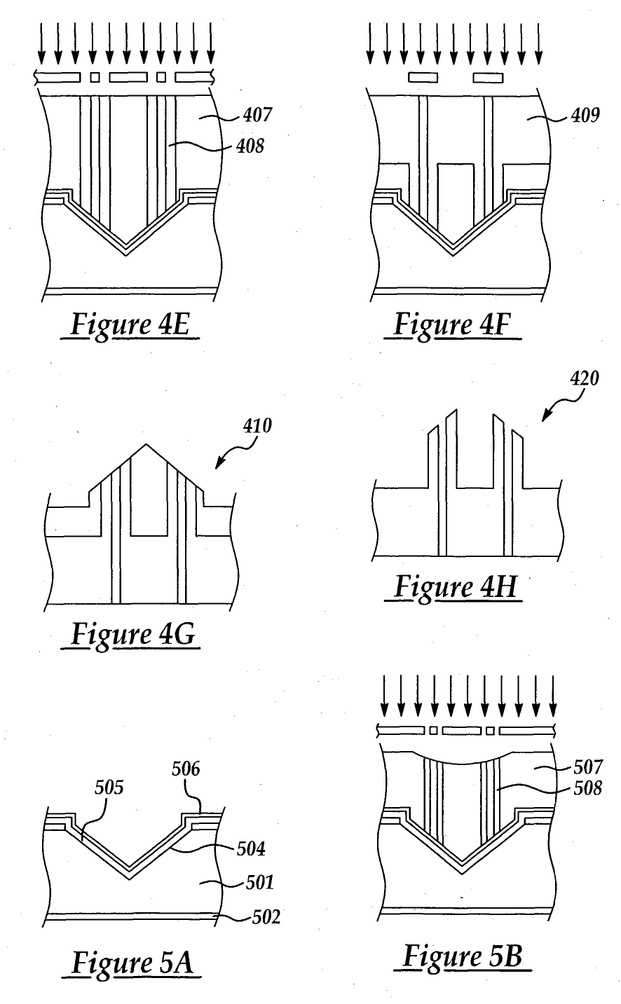

The present invention micro-needle array may further be fabricated by imaging and molding processes. This is shown in FIGS. 4A-4H in a fourth preferred embodiment for the present invention. As shown in FIG. 4A, on top of a silicon wafer 401 is first deposited an etch protective layer 402. A photoresist layer is then deposited and imaged to define areas to be etched, shown in FIG. 4B. The etch protective layer 402 is then etched to obtain a wet etch region 403. In the next step of the process, shown in FIG. 4C, an anisotropic etching (wet etching) process is carried out on the silicon wafer 401 to obtain a recess. 404 that has inclined sidewalls. An anti-reflective coating layer such as a black photoresist layer 405 is then coated, as shown in FIG. 4D, followed by the coating of a sacrificial layer such as gold or a mold release layer such as teflon or silicon rubber (PDMS) coating 406. A photoresist layer 407 is then deposited on top of the structure, as shown in FIG. 4E. A first imaging process is carried out to obtain a first exposed area 408. A second imaging process is then carried out, as shown in FIG. 4F, to obtain the shape of the micro-needle in a second exposed area 409. The sacrificial layer 406 is then removed, as shown in FIG. 4G. The structure may also be demolded directly to obtain a bottom layer 410 is developed with inclined sidewalls. In the final step shown in FIG. 4H, the bottom layer 410 is developed to obtain the micro-needle array 420.

In the process discussed above, the major purpose of the anti-reflective coating layer 405 is to prevent any over-exposure of the photoresist layer due to the different exposure depth. The sequence for depositing the anti-reflective layer 405 and the sacrificial layer 406 (or the mold release layer) may be reversed. It is also possible to first demold and then carry out the imaging/developing step.

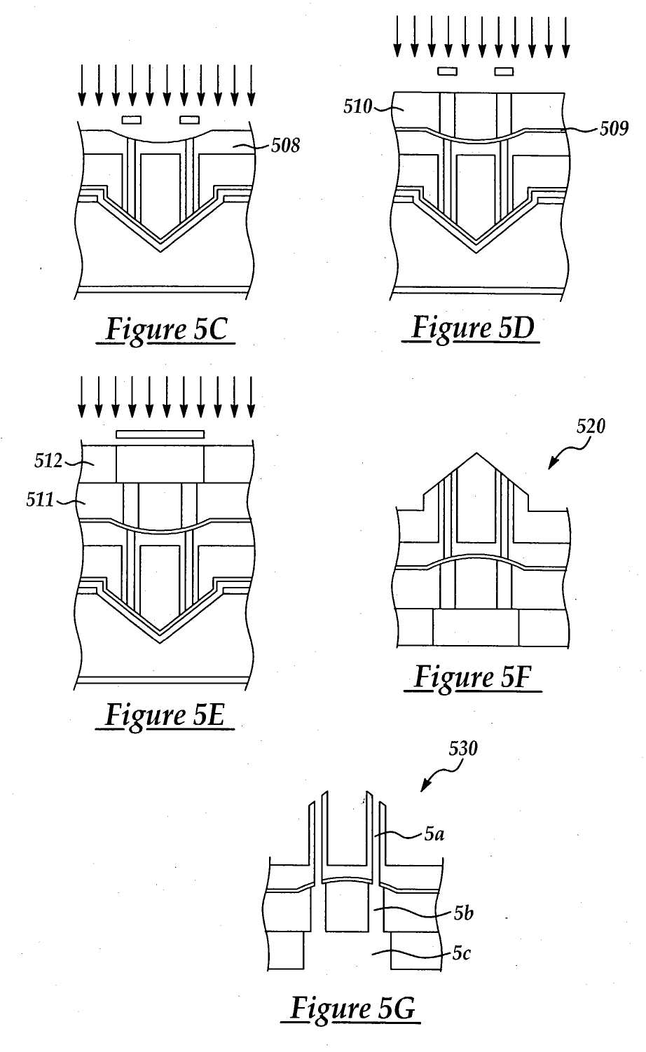

In still another preferred embodiment of the present invention, more than one layer of a photoresist material may be used to change the internal passageway in the micro-needle, or to merge various internal passageways into a single, large passageway for taking blood samples or for delivering fluid. This is illustrated in FIGS. 5A-5G in a fifth preferred embodiment of the present invention fabrication method. In the first step of the process, shown in FIG. 5A, a recess 504 with inclined sidewalls is first etched on a silicon wafer 501 covered with a protective layer 502. An anti-reflective layer 505, a sacrificial layer (or mold release layer) 506 are then sequentially deposited. As shown in FIG. 5B, a first photoresist layer 507 is coated for carrying out a first imaging/exposure to obtain a first exposure zone 508. A second exposure is then carried out, as shown in FIG. 5C. An anti-reflective coating layer 509, a second photoresist layer 510 are then coated and a third exposure process is carried out. This is shown in FIG. 5D. Another layer of anti-reflective coating 511, and a second photoresist layer 512 are then sequentially deposited and a fourth exposure process is carried out, as shown in FIG. 5E. The sacrificial layer 505 is then removed, or the structure is directly demolded, as shown in FIG. 5F to obtain a bottom structure 520 that has inclined surfaces. The bottom structure is then developed to obtain the micro-needle array 530, as shown in FIG. 5G.

In the fifth preferred embodiment, the deposition process for the anti-reflective coating layer and for the sacrificial layer (or the mold release layer) may be reversed in sequence. For different structures or configurations, one of the layers also may not be necessary. The second exposure process may further be saved, despite the fact that a stronger bottom structure can be obtained when the second exposure process is used. The photoresist layer may be selected from either a positive photoresist or a negative photoresist. More than one layer of photoresist layer may also be used to form internal passageways of various sizes, i.e., the internal passageway 5A, 5B. The internal passageway may also be connected into an interconnecting network, shown as passageway 5C or a storage region as shown in FIG. 5G.

The above-described process can also be used to form micro-needles that have various inclined surface structures at the needle tip. For instance, a single inclined surface is shown in FIG. 6A, double inclined surfaces are shown in FIG. 7A, other types of inclined surfaces are shown in FIGS. 6B and 6C.

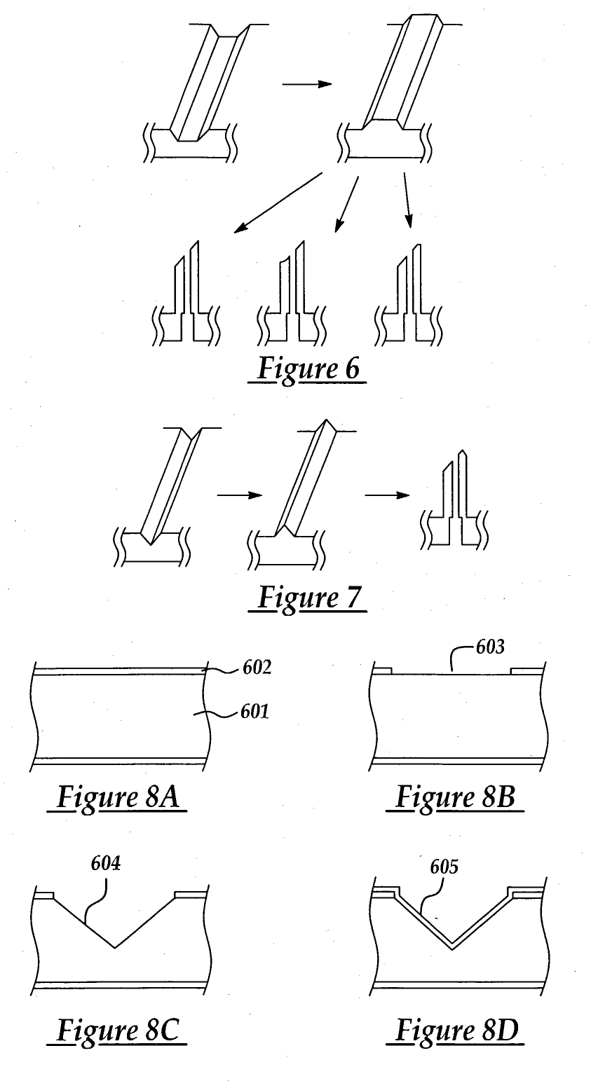

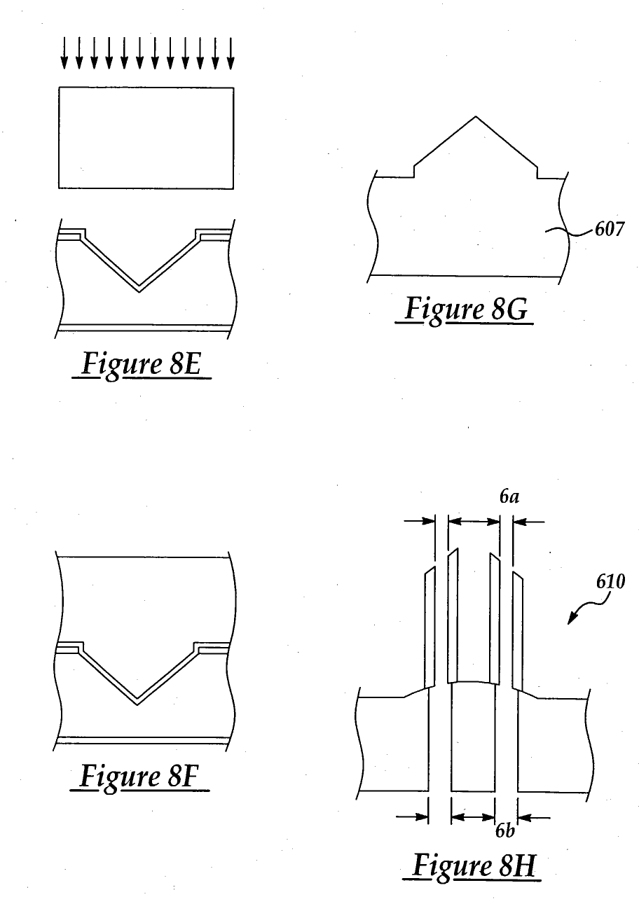

FIGS. 8A-8G illustrates a sixth preferred embodiment of the present invention fabrication process. For instance, FIG. 8A illustrates that a protective layer 602 is first deposited on top of the silicon wafer 601. A wet etch area 603 is then defined, shown in FIG. 8B. The silicon wafer 601 is then etched to obtain a recess 604 equipped with inclined sidewalls. This is shown in FIG. 8C. A sacrificial layer 605 or a mold release layer is then deposited, as shown in FIG. 8D. Shown in FIGS. 8E-8G, a plastic material 606 is used to thermal pressure forming a bottom structure 607 equipped with inclined surfaces. The sacrificial layer 605 is then removed, or demolded. A micro-processing technique is then used to define the internal passageways 6a and 6b, as shown in FIG. 8H forming the micro-needle array 610. The plastic material utilized may be a thermoset material or a thermoplastic material. The micro-processing technique utilized may be laser processing or etching. The bottom structure 607 may also be formed by an injection molding process.

While the present invention has been described in an illustrative manner, it should be understood that the terminology used is intended to be in a nature of words of description rather than of limitation.

Furthermore, while the present invention has been described in terms of one preferred and five alternate embodiments, it is to be appreciated that those skilled in the art will readily apply these teachings to other possible variations of the inventions.

The embodiment of the invention in which an exclusive property or privilege is claimed are defined as follows.

1. A method for fabricating a hollow micro-needle array comprising the steps of:
providing a silicon substrate;
depositing a protective layer on said silicon substrate;
defining a plurality of regions for wet etching;
wet etching said silicon substrate forming a plurality of recesses having inclined sidewalls; and
continuing processing said plurality of recesses forming a hollow micro-needle array.

2. A method for fabricating a hollow micro-needle array according to claim 1, wherein said continuing processing step is selected from the group consisting of electroplating, imaging/developing and micro-electrical-mechanical machining.

3. A method for fabricating a hollow micro-needle array according to claim 1 further comprising the step of providing a polymeric substrate instead of the silicon substrate, and forming said plurality of recesses with inclined sidewalls by a laser processing technique.

4. A method for fabricating a hollow micro-needle array according to claim 1 further comprising the step of providing a photoresist material instead of said silicon substrate, and forming said plurality of recesses having inclined sidewalls by imaging and developing.

5. A method for fabricating a hollow micro-needle array according to claim 1, wherein a tip portion of a micro-needle in said hollow micro-needle array is at least partially formed in a tapered shape.

6. A method for fabricating a hollow micro-needle array according to claim 1, wherein said continuing processing step further comprises the sub-steps of:
photolithographically depositing a photoresist material on top of said silicon substrate and forming a plurality of recesses;
plating a metal in said plurality of recesses forming a plurality of metal micro-needles;
removing said photoresist material exposing said plurality of hollow metal micro-needles; and
etching said silicon substrate forming a plurality of hollow metal micro-needles.

7. A method for fabricating a hollow micro-needle array according to claim 6 further comprising the step of:
depositing a starting metal layer on said silicon substrate in said plurality of recesses having inclined sidewalls.

8. A method for fabricating a hollow micro-needle array according to claim 6, wherein said plating step is selected from the group consisting of electroplating, electroless plating evaporation and sputtering.

9. A method for fabricating a hollow micro-needle array according to claim 6, wherein said metal is selected from the group consisting of copper, chromium, nickel, iron, gold, platinum, palladium and their alloys, and stainless steel.

10. A method for fabricating a hollow micro-needle array according to claim 6, wherein said removal step for said photoresist material and said hollowing process of the micro-needle are carried out by a technique selected from the group consisting of laser processing, etching and photolithography.

11. A method for fabricating a hollow micro-needle array according to claim 6 further comprising the step of using said silicon substrate with said metal micro-needle as a mold for fabricating a multiplicity of micro-needles.

12. A method for fabricating a hollow micro-needle array according to claim 11, wherein said multiplicity of micro-needles can be fabricated by micro-injection molding or a micro-thermal compression forming technique.

13. A method for fabricating a hollow micro-needle array comprising the steps of:
providing a silicon substrate;
depositing a protective layer on said silicon substrate;
defining a plurality of wet etch regions;
wet etching the plurality of wet etch regions on said silicon substrate forming a plurality of recesses each having inclined sidewalls;
depositing sequentially an anti-reflective coating layer and a sacrificial layer on top of said silicon substrate;
depositing a photoresist layer;
imaging said photoresist layer for said micro-needle array;
removing said sacrificial layer obtaining a bottom layer with inclined sidewalls; and
developing said bottom layer forming a micro-needle array.

14. A method for fabricating a hollow micro-needle array according to claim 13 further comprising the step of, after the deposition of said photoresist layer, removing said sacrificial layer and then imaging and developing said bottom layer.

15. A method for fabricating a hollow micro-needle array according to claim 13, wherein said sacrificial layer is a mold release layer.

16. A method for fabricating a hollow micro-needle array according to claim 13 further comprising repeated steps of depositing said photoresist layer and imaging said photoresist layer such that an internal diameter of the flow passage in said micro-needle array is changed for serving as a storage function.

17. A method for fabricating a hollow micro-needle array comprising the steps of:
providing a silicon substrate;
depositing a protective layer on top of said silicon substrate;
defining a plurality of wet etching regions;
wet etching said silicon substrate forming a plurality of recesses each having inclined sidewalls;
depositing a sacrificial layer on top of said silicon substrate;
compression molding by using a material having sufficient plasticity;
removing said sacrificial layer obtaining a bottom layer having inclined sidewalls; and
micro-machining said silicon substrate obtaining a micro-needle array.

18. A method for fabricating a hollow micro-needle array according to claim 17, wherein said sacrificial layer is a mold release layer.

19. A method for fabricating a hollow micro-needle array according to claim 17, wherein said material with sufficient plasticity is selected from the group consisting of hot solid material and hot molding material.

20. A method for fabricating a hollow micro-needle array according to claim 17, wherein said compression molding step of said material with sufficient plasticity is replaced by an injection molding process for said material with sufficient plasticity.

21. A method for fabricating a hollow micro-needle array according to claim 17, wherein said micro-processing step comprises laser processing steps or etching steps.
